(19) United States
(12) Patent Application Publication
(10) Pub. No.: US 2013/0321115 A1
(43) Pub. Date: Dec. 5, 2013

(54) MULTILAYERED-TYPE INDUCTOR AND METHOD OF MANUFACTURING THE SAME

(71) Applicant: Han LEE, Suwon (KR)

(72) Inventor: Han LEE, Suwon (KR)

(73) Assignee: SAMSUNG ELECTRO-MECHANICS CO., LTD.

(21) Appl. No.: 13/620,454

(22) Filed: Sep. 14, 2012

(30) Foreign Application Priority Data
May 30, 2012 (KR) 10-2012-0057334

(51) Int. Cl. H01F 5/00; H01F 41/32; H01F 41/00

(52) U.S. Cl. 336/200; 156/89.12

(57) ABSTRACT

There is provided a multilayered-type inductor including: a body in which a plurality of sheets are multilayered; and a plurality of internal electrode patterns formed on respective sheets and connected to each other by a conductive via, wherein the plurality of internal electrode patterns include first and second internal electrode patterns having different internal diameters such that they do not overlap each other on respective sheets in a thickness direction of the body, and alternately disposed in the thickness direction of the body.

### CROSS-REFERENCE TO RELATED APPLICATIONS

This application claims the priority of Korean Patent Application No. 10-2012-0057334 filed on May 30, 2012, in the Korean Intellectual Property Office, the disclosure of which is incorporated herein by reference.

### BACKGROUND OF THE INVENTION

1. Field of the Invention

The present invention relates to a multilayered-type inductor and a method of manufacturing the same.

2. Description of the Related Art

An inductor is one of the main passive elements constituting an electronic circuit, together with a resistor and a capacitor.

The inductor may be used in a component removing noise or constituting an LC resonance circuit, and the like.

The inductor may be classified as one of various types thereof, such as a winding-type inductor, a thin film-type inductor, a multilayered-type inductor, and the like, according to a structure thereof.

The winding type inductor or the thin film-type inductor may be manufactured by winding a coil around, or printing the coil on, a ferrite core and forming electrodes at both ends thereof.

The multilayered-type inductor may be manufactured by printing internal electrode patterns on a plurality of sheets formed of a magnetic material, a dielectric material, or the like, and then multi-layering the plurality of sheets in a thickness direction thereof.

In particular, since the multilayered-type inductor may have a reduced overall size and thickness, as compared to the winding type inductor, and is advantageous for direct current (DC) resistance, it may be widely used in a power supply circuit requiring miniaturization and a high current.

In the multilayered-type inductor, a multilayered body is formed by printing internal electrode patterns on sheets formed of a magnetic material and then vertically multi-layering the sheets.

In this case, in the multilayered-type inductor, parasitic capacitance and resistance as well as inductance are provided.

Parasitic capacitance or resistance, causing a deterioration of inductance characteristics in the multilayered-type inductor, should have as small a value as possible, in order to improve product quality.

A quality coefficient through a mutual relationship between inductance, capacitance, and resistance of the inductor is called a quality factor.

In general, in the case in which the quality factor is improved in the inductor, noise removal characteristics or efficiency of the inductor may be improved.

Therefore, in accordance with the recent trend for an increase in usage frequency and power consumption of an electronic product, research into a multilayered-type inductor having an excellent quality factor has been actively conducted.

The following Patent Documents 1 and 2 disclose a chip component.

In Patent Document 1, an internal electrode pattern of a surface layer sheet is internally formed, as compared to an internal electrode pattern of a coil pattern, by a predetermined width.

In Patent Document 2, a plurality of internal electrodes are formed in patterns having different widths.

Patent Documents 1 and 2 do not disclose a structure in which internal electrode patterns are alternately formed in positions in which they are not overlapped with each other in a multilayered direction.

### RELATED ART DOCUMENT

(Patent Document 1) Korean Patent No. 10-0513347
(Patent Document 2) Korean Patent Laid-Open Publication No. 10-2005-0055264

### SUMMARY OF THE INVENTION

An aspect of the present invention provides a multilayered-type inductor having an improved quality factor by increasing an interval between internal electrode patterns to decrease parasitic capacitance between the internal electrode patterns, while having an internal diameter of a coil similar to that of a multilayered-type inductor according to the related art to constantly maintain an inductance value.

According to an aspect of the present invention, there is provided a multilayered-type inductor including: a body in which a plurality of sheets are multilayered; and a plurality of internal electrode patterns formed on respective sheets and connected to each other by a conductive via, wherein the plurality of internal electrode patterns include first and second internal electrode patterns having different internal diameters such that they do not overlap each other on respective sheets in a thickness direction of the body, and alternately disposed in the thickness direction of the body.

The first internal electrode pattern may have an internal diameter larger than that of the second internal electrode pattern by a distance equal to a width of the second internal electrode pattern.

The conductive via of the second internal electrode pattern may be protruded from the second internal electrode pattern toward a side surface of the sheets by a distance equal to a width of the first internal electrode pattern, so as to be connected to the conductive via of the first internal electrode pattern adjacent thereto.

Thicknesses of the first and second internal electrode patterns may be 10 to 100 μm.

The first and second internal electrode patterns may have the same thickness, or at least parts of the first and second internal electrode patterns may have a different thickness.

The first or second internal electrode pattern may be spaced apart from another first or second internal electrode pattern adjacent thereto by 10 to 100 μm.

The multilayered-type inductor may further include an upper cover layer or a lower cover layer formed on an upper surface or a lower surface of the body.

The multilayered-type inductor may further include external electrodes formed on both ends of the body and electrically connected to the internal electrode patterns.

According to another aspect of the present invention, there is provided a method of manufacturing a multilayered-type inductor including: preparing a plurality of sheets formed of a material including a magnetic material or a dielectric material; separately forming first or second internal electrode patterns on each of the sheets such that the first and second internal electrode patterns have different internal diameters so as not to overlap each other; forming conductive vias in each of the sheets having the first or second internal electrode patterns formed thereon; alternately multi-layering the sheets having the first internal electrode patterns formed thereon and sheets having the second internal electrode patterns formed thereon so that a coil part is configured by allowing the conductive vias formed in adjacent sheets to contact each other, thereby forming a multilayered body; and forming a ceramic body by firing the multilayered body.

In the forming of the first and second internal electrode patterns, the internal diameter of the first internal electrode patterns may be formed to be larger than that of the second internal electrode patterns by a distance equal to a width of the second internal electrode patterns.

In the forming of the conductive vias, first conductive vias may be formed at both ends of the first internal electrode patterns, and second conductive vias may be formed in positions in which they are protruded from both ends of the second internal electrode patterns by a distance equal to a width of the first internal electrode patterns, so as to be connected to the first conductive vias.

In the forming of the first and second internal electrode patterns, thicknesses of the first and the second internal electrode patterns may be formed to be 10 to 100 μm.

In forming of the first and second internal electrode patterns, the thicknesses of the first and second internal electrode patterns may be the same as each other, at least parts of the first and second internal electrode patterns may be formed to have a different thickness.

In the preparing of the sheets, the thicknesses of the sheets may be formed to be 10 to 100 μm so that an interval between the first or second internal electrode patterns adjacent to each other is 10 to 100 μm when the sheets having the first or second internal electrode patterns formed thereon are multilayerd.

The method may further include, after the forming of the multilayered body, forming an upper cover layer or a lower cover layer on an upper surface or a lower surface of the multilayered body, respectively.

The method may further include, after the forming of the ceramic body, forming external electrodes on both ends of the body so as to be electrically connected to the first or second internal electrode patterns.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing a multilayered-type inductor according to an embodiment of the present invention;

FIG. 2 is an exploded perspective view showing a structure in which internal electrode patterns of the multilayered-type inductor according to the embodiment of the present invention are disposed;

FIG. 3 is a cross-sectional view taken along line A-A′ of FIG. 1;

FIG. 4 is a cross-sectional view taken along line B-B′ of FIG. 1; and

FIG. 5 is a schematic diagram describing parasitic capacitance between internal electrode patterns in a general multilayered-type inductor.

### DETAILED DESCRIPTION OF THE INVENTION

Embodiments of the present invention will now be described in detail with reference to the accompanying drawings.

The embodiments of the present invention may be modified in many different forms and the scope of the invention should not be seen as being limited to the embodiments set forth herein.

In addition, these embodiments are provided so that this disclosure will be thorough and complete, and will fully convey the concept of the invention to those skilled in the art.

Therefore, in the drawings, the shapes and dimensions of elements may be exaggerated for clarity, and the same reference numerals will be used throughout to designate the same or like components.

In addition, like reference numerals denote parts performing similar functions and actions throughout the drawings.

In addition, unless explicitly described otherwise, “comprising” any components will be understood to imply the inclusion of other components but not the exclusion of any other components.

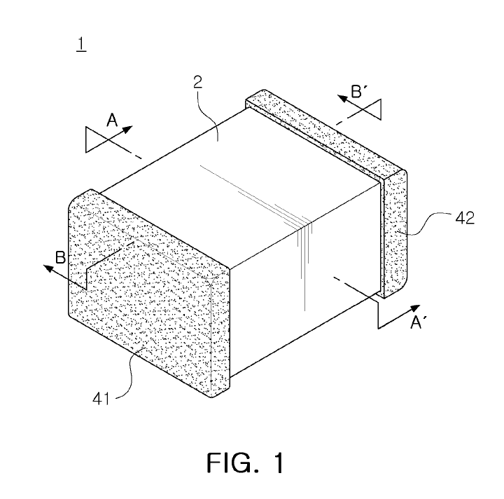

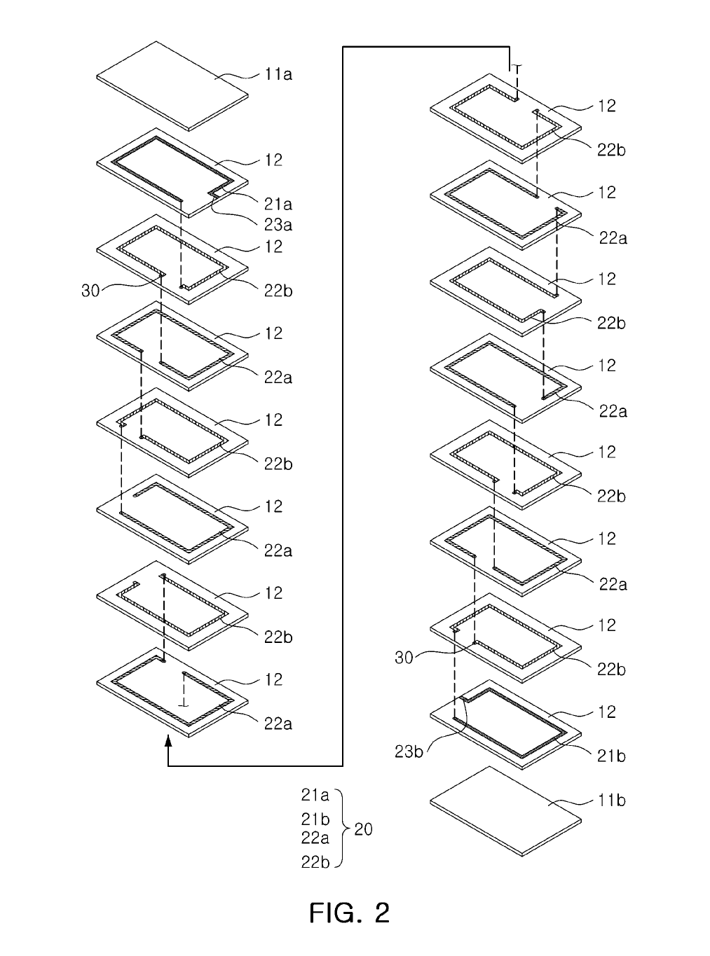

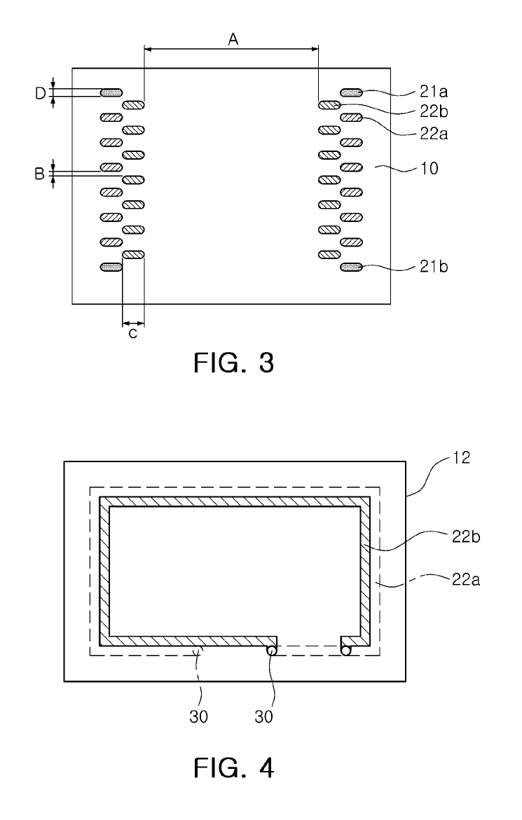

Referring to FIGS. 1 through 4, a multilayered-type inductor 1 according to an embodiment of the present invention may include a body 2 in which a plurality of sheets 12 are multilayered, and a plurality of internal electrode patterns 21a, 21b, 22a, and 22b formed on respective sheets 12 and electrically connected to each other through conductive vias 30.

Here, an upper cover layer 11a and a lower cover layer 11b may be formed on upper and lower surfaces of the body 2 in order to protect the plurality of internal electrode patterns 21a, 21b, 22a, and 22b printed within the body 2.

In general, the multilayered-type inductor may have inductance, capacitance, and resistance as characteristic values.

In addition, the plurality of internal electrode patterns 21a, 21b, 22a and 22b formed in the multilayered-type inductor may store energy delivered from the outside therein. The stored energy may be gradually diminished with the passage of time due to parasitic capacitance and resistance between the internal electrode patterns 21a, 21b, 22a, and 22b of a spiral shaped coil 20, in which the plurality of internal electrode patterns 21a, 21b, 22a, and 22b are electrically connected to each other.

In this case, in order to define a degree of loss generated due to the diminution, a quality factor is introduced.

In general, Q=X/R, where X indicates resistance due to inductance of the coil, and R indicates ohmic resistance.

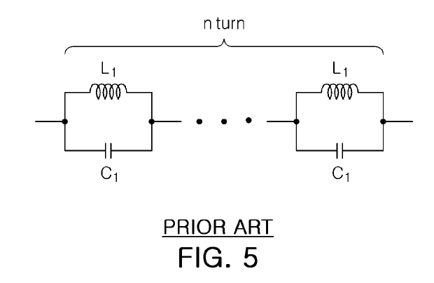

Referring to FIG. 5, an equation X=(1+jωL)/(1+jω²LC) may be represented in consideration of parasitic capacitance between the internal electrode patterns 21a, 21b, 22a, and 22b. Thus, as parasitic capacitance increases, a value of X may be decreased in inverse proportion to the parasitic capacitance, and accordingly, a value of Q may also be decreased in proportion to the value of X.

Meanwhile, both end surfaces of the body 2 may be provided with a pair of external electrodes 41 and 42 contacting the internal electrode patterns 21a and 21b exposed to the outside through both end surfaces of the sheets 12 formed on upper and lower outer layers of the body 2, to be electrically connected thereto.

Here, the internal electrode patterns 21a and 21b positioned at an uppermost portion and a lowermost portion among the internal electrode patterns 21a, 21b, 22a, and 22b may have output terminals 23a, 23b extended so as to be exposed to the outside through respective single end surfaces of the sheets 12 formed on the outer layers of the body 2.

The external electrodes 41 and 42 may be formed of a conductive metal material having an excellent electrical conductivity.

For example, the external electrodes 41 and 42 may be formed of a material including at least one of silver (Ag) and copper (Cu), or an alloy thereof, but is not limited thereto.

In addition, a nickel (Ni) layer (not shown) and a tin (Sn) layer (not shown) may be sequentially formed on outer surfaces of the external electrodes 41 and 42 as a plating layer, if needed.

The internal electrode patterns may include first internal electrode patterns 21a, 21b, and 22a having relatively larger internal diameters, and a second internal electrode pattern 22b having an internal diameter A smaller than those of the first internal electrode patterns 21a, 21b, and 22a.

The first internal electrode patterns 21a, 21b, and 22a, and the second internal electrode pattern 22b may be alternately and vertically formed on a one-by-one basis in a direction in which the sheets 12 configuring the body 2 are multilayered, so as not to overlap each other.

Here, an interval B by which respective first and second internal electrode patterns 21a, 21b, 22a, and 22b are vertically adjacent to each other may be 10 to 100 μm in order to significantly decrease a magnitude of parasitic capacitance between the patterns. In order to maintain the interval, a thickness of each of the sheets may be 10 to 100 μm.

In addition, the first internal electrode patterns 21a, 21b, and 22a may be formed to have an internal diameter larger than that of the second internal electrode pattern by a distance equal to a width (C) of the second internal electrode pattern.

In addition, a thickness D of respective first and second internal electrode patterns 21a, 21b, 22a, and 22b may be as thick as possible within the range in which a resistance value (Rdc) is maintained at a predetermined level, preferably, 10 to 100 μm.

Here, the first and second internal electrode patterns 21a, 21b, 22a, and 22b may have the same thickness, or at least parts of the internal electrode patterns 21a, 21b, 22a, and 22b may have a different thickness from those of the other internal electrode patterns, if needed.

As described above, in the case in which respective internal diameters of the first and second internal electrode patterns 21a, 21b, 22a, and 22b are controlled within a range in which adjacent first or second internal electrode patterns 21a, 21b, and 22a, or 22b do not overlap each other and a thickness D of each of the first and second internal electrode patterns 21a, 21b, 22a, and 22b increases by as much as possible within the range in which the resistance value Rdc is maintained at a predetermined level, the internal diameter A of the coil 20 formed of the first and second internal electrode patterns 21a, 21b, 22a, and 22b may be same as that of a multilayered-type inductor of the related art in which internal electrode patterns having the same internal diameter are vertically and continuously multilayered, such that an inductance value thereof may be maintained to be similar to that of the multilayered-type inductor of the related art, and the interval B between the internal electrode patterns 21a, 21b, 22a, and 22b may be wider than that of the multilayered-type inductor according to the related art, such that parasitic capacitance between the internal electrode patterns 21a, 21b, 22a, and 22b may be decreased, thereby significantly improving quality factor of the multilayered-type inductor.

The first and second internal electrode patterns 21a, 21b, 22a, and 22b may be formed of a conductive metal material having excellent electrical conductivity.

For example, the first and second internal electrode patterns 21a, 21b, 22a, and 22b may be formed of a material including silver (Ag) or copper (Cu), or an alloy thereof, but are not limited thereto.

In addition, the number of sheets 12 multilayered and having the first and second internal electrode patterns 21a, 21b, 22a, and 22b formed therein may be variously determined in consideration of electrical characteristics such as an inductance value required for the multilayered-type inductor 1 to be designed, or the like.

Meanwhile, in the embodiment, the respective first and second internal electrode patterns 21a, 21b, 22a, and 22b may have a pair of the conductive vias 30 formed at both ends thereof, spaced apart from each other and penetrating the sheet 12 in a thickness direction thereof. The first and second internal electrode patterns 21a, 21b, 22a, and 22b adjacently positioned in a vertical direction may be continuously and electrically connected to each other through the conductive vias 30.

In respective first and second internal electrode patterns 21a, 21b, 22a, and 22b, positions of the conductive vias 30 are sequentially changed in a direction, such that respective first and second internal electrode patterns 21a, 21b, 22a, and 22b may form the spiral-shaped coil 20 which is entirely connected.

Here, the conductive vias 30 may be formed by forming through-holes (not shown) in each sheet 12 and then filling the through-holes with a conductive paste having excellent electrical conductivity.

The conductive paste may be formed of at least one of silver (Ag), silver-palladium (Ag—Pd), nickel (Ni) and copper (Cu) or an alloy thereof, for example, but is not limited thereto.

Meanwhile, the conductive vias 30 of the second internal electrode pattern 22b in the embodiment may be protruded in an outward direction of the sheet 12 by a distance equal to a width of the first internal electrode patterns 21a, 21b, and 22a so as to vertically contact the conductive vias 30 formed in the first internal electrode patterns 21a, 21b, and 22a, corresponding to the internal diameters of the first internal electrode patterns 21a, 21b, and 22a.

Hereinafter, a method of manufacturing a multilayered-type inductor according to an embodiment of the present invention will be described.

A plurality of the sheets 12 formed of a material including a magnetic material, a dielectric material, or the like are first prepared.

The number of sheets 12 multilayered according to the present invention is not limited, but may be determined according to a use object of the multilayered-type inductor.

Next, the first internal electrode patterns 21a, 21b, and 22a, and the second internal electrode pattern 22b having the internal diameter smaller than those of the first internal electrode patterns 21a, 21b, and 22a are separately formed on respective sheets 12.

Here, the internal diameters of the first internal electrode patterns 21a, 21b, 22a may be larger than that of the second internal electrode pattern 22b by a distance equal to a width of the second internal electrode pattern 22b.

The first and second internal electrode patterns 21a, 21b, 22a, and 22b according to the present invention may be formed of a material having an excellent electrical conductivity, and for example, include a conductive material such as silver (Ag) or copper (Cu) or an alloy thereof, but are not limited thereto.

Here, the first and second internal electrode patterns 21a, 21b, 22a, and 22b may be formed by a general method, for example, one of a thick film printing method, an applying method, a depositing method, and a sputtering method, and the like. However, the present invention is not limited thereto.

The conductive vias 30 are formed in respective sheets 12 manufactured as above.

The conductive vias 30 may be formed by forming through-holes in the respective sheets 12 and then filling the through-holes with a conductive paste, or the like.

Here, first conductive vias may be formed at both ends of the first internal electrode patterns 21a, 21b, and 22a, and second conductive vias may be formed in positions in which they are protruded from both ends of the second internal electrode pattern 22b by a distance equal to a width of the first internal electrode patterns 21a, 21b, and 22a so as to be connected to the first conductive vias.

The conductive paste may be formed of a material having excellent electrical conductivity, and include at least one of silver (Ag), silver-palladium (Ag—Pd), nickel (Ni) and copper (Cu) or an alloy thereof, but is not limited thereto.

Next, a plurality of the sheets 12 having the first internal electrode patterns 21a, 21b, and 22b formed thereon, and a plurality of sheets 12 having the second internal electrode pattern 22b formed thereon are alternately multilayered so that a single coil 20 in which the first internal electrode patterns 21a, 21b, and 22a, and the second internal electrode 22b come into contact with each other through the conductive vias 30 formed in the adjacent sheets 12 without overlapping each other, thereby forming a multilayered body.

Here, the upper cover layer 11a and the lower cover layer 11b may be formed, respectively, by multi-layering at least one upper or lower cover sheet on an upper surface or a lower surface of the multilayered body or printing a paste formed of the same material as the sheet 12 configuring the multilayered body at a predetermined thickness.

Next, a ceramic body 2 is formed by firing the multilayered body.

Next, the external electrodes 41 and 42 may be formed so as to be electrically connected to the first and second internal electrode patterns 21a and 21b exposed to the outside on both ends of the body 2, respectively.

In the embodiment, an end portion of the first internal electrode patterns 21a and 21b positioned at the uppermost portion and the lowermost portion among the internal electrode patterns 21a, 21b, 22a, and 22b is extended to each of output terminals 23a and 23b so as to be exposed through one end surface of the sheet 12. The external electrodes 41 and 42 are formed so as to contact the output terminals 23a and 23b at both ends of the body 2, respectively.

The external electrodes 41 and 42 according to the present invention may be formed of a material having excellent electrical conductivity including a conductive material such as silver (Ag) or copper (Cu) or an alloy thereof, but are not limited thereto.

In addition, a plating layer may be further formed by plating nickel (Ni) or tin (Sn) on surfaces of the external electrodes 41 and 42 formed as described above, if needed.

Here, the external electrodes 41 and 42 may be formed by any one of conventional methods, for example, thick film printing, applying, depositing, and sputtering, and the like, but are not limited thereto.

As set forth above, according to the embodiment of the present invention, the internal electrode patterns are alternately multilayered while not overlapping each other by differentiating internal diameters thereof, and widths of respective internal electrode patterns are significantly decreased to 10 to 100 μm to allow a thickness of the internal electrode patterns to be as thick as possible in the range in which a resistance value (Rdc) is maintained at a predetermined level, such that an internal diameter of the coil is constantly maintained to maintain an inductance value at a constant level and the interval between internal electrode patterns is increased to decrease parasitic capacitance between the internal electrode patterns, thereby improving the quality factor. Therefore, noise removal characteristics or electrical efficiency of the multilayered-type inductor may be improved.

While the present invention has been shown and described in connection with the embodiments, it will be apparent to those skilled in the art that modifications and variations can be made without departing from the spirit and scope of the invention as defined by the appended claims.

What is claimed is:

1. A multilayered-type inductor comprising:
a body in which a plurality of sheets are multilayered; and
a plurality of internal electrode patterns formed on respective sheets and connected to each other by a conductive via,
wherein the plurality of internal electrode patterns include first and second internal electrode patterns having different internal diameters such that they do not overlap each other on respective sheets in a thickness direction of the body, and alternately disposed in the thickness direction of the body.

2. The multilayered-type inductor of claim 1, wherein the first internal electrode pattern has an internal diameter larger than that of the second internal electrode pattern by a distance equal to a width of the second internal electrode pattern.

3. The multilayered-type inductor of claim 2, wherein the conductive via of the second internal electrode pattern is protruded from the second internal electrode pattern toward a side surface of the sheets by a distance equal to a width of the first internal electrode pattern, so as to be connected to the conductive via of the first internal electrode pattern adjacent thereto.

4. The multilayered-type inductor of claim 1, wherein thicknesses of the first and second internal electrode patterns are 10 to 100 μm.

5. The multilayered-type inductor of claim 4, wherein the first and second internal electrode patterns have the same thickness.

6. The multilayered-type inductor of claim 4, wherein at least parts of the first and second internal electrode patterns have a different thickness.

7. The multilayered-type inductor of claim 1, wherein the first or second internal electrode pattern is spaced apart from another first or second internal electrode pattern adjacent thereto by 10 to 100 μm.

8. The multilayered-type inductor of claim 1, further comprising an upper cover layer or a lower cover layer formed on an upper surface or a lower surface of the body.

9. The multilayered-type inductor of claim 1, further comprising external electrodes formed on both ends of the body and electrically connected to the internal electrode patterns.

10. A method of manufacturing a multilayered-type inductor, the method comprising:
preparing a plurality of sheets formed of a material including a magnetic material or a dielectric material;
separately forming first or second internal electrode patterns on each of the sheets such that the first and second internal electrode patterns have different internal diameters so as not to overlap each other;
forming conductive vias in each of the sheets having the first or second internal electrode patterns formed thereon;
alternately multi-layering the sheets having the first internal electrode patterns formed thereon and sheets having the second internal electrode patterns formed thereon so that a coil part is configured by allowing the conductive vias formed in adjacent sheets to contact each other, thereby forming a multilayered body; and
forming a ceramic body by firing the multilayered body.

11. The method of claim 10, wherein in the forming of the first and second internal electrode patterns, the internal diameter of the first internal electrode patterns is formed to be larger than that of the second internal electrode patterns by a distance equal to a width of the second internal electrode patterns.

12. The method of claim 10, wherein in the forming of the conductive vias, first conductive vias are formed at both ends of the first internal electrode patterns, and second conductive vias are formed in positions in which they are protruded from both ends of the second internal electrode patterns by a distance equal to a width of the first internal electrode patterns, so as to be connected to the first conductive vias.

13. The method of claim 10, wherein in the forming of the first and second internal electrode patterns, thicknesses of the first and the second internal electrode patterns are formed to be 10 to 100 μm.

14. The method of claim 13, wherein in the forming of the first and second internal electrode patterns, the thicknesses of the first and second internal electrode patterns are the same as each other.

15. The method of claim 13, wherein in the forming of the first and second internal electrode patterns, at least parts of the first and second internal electrode patterns are formed to have a different thickness.

16. The method of claim 13, wherein in the preparing of the sheets, the thicknesses of the sheets are formed to be 10 to 100 μm so that an interval between the first or second internal electrode patterns adjacent to each other is 10 to 100 μm when the sheets having the first or second internal electrode patterns formed thereon are multilayered.

17. The method of claim 10, further comprising, after the forming of the multilayered body, forming an upper cover layer or a lower cover layer on an upper surface or a lower surface of the multilayered body, respectively.

18. The method of claim 10, further comprising, after the forming of the ceramic body, forming external electrodes on both ends of the body so as to be electrically connected to the first or second internal electrode patterns.
